(19) United States
(12) Patent Application Publication
(10) Pub. No.: US 2014/0317267 A1
(43) Pub. Date: Oct. 23, 2014

(54) High-Density Server Management Controller

(71) Applicant: ADVANCED MICRO DEVICES, INC., Sunnyvale, CA (US)

(72) Inventors: Hari Ramachandran, Austin, TX (US); Ravi Bingi, Austin, TX (US); Ranger H. Lam, Austin, TX (US)

(73) Assignee: Advanced Micro Devices, Inc., Sunnyvale, CA (US)

(21) Appl. No.: 13/867,638

(22) Filed: Apr. 22, 2013

(51) Int. Cl. H04L 12/24; H04L 12/26

(52) U.S. Cl. CPC H04L 41/24; H04L 43/00
USPC 709/224; 709/223

(57) ABSTRACT

The described embodiments include a system management controller for managing servers on a plurality of sled devices. The system management controller includes a processing mechanism and a plurality of internal interfaces coupled to the processing mechanism. Each internal interface in the system management controller is coupled to at least one embedded management controller on each of the sled devices, the at least one embedded management controller on each sled device facilitating communications between the processing mechanism in the system management controller and a corresponding server on the sled device. In these embodiments, the processing mechanism in the system management controller is configured to manage one or more operations of the servers on the plurality of sled devices.

### BACKGROUND

1. Field

The described embodiments relate to computing devices. More specifically, the described embodiments relate to a management controller for high-density servers.

2. Related Art

Modern server computer systems (“servers”) typically include a baseboard management controller (BMC) that is used for monitoring the server and causing the server to perform actions. The BMC is a dedicated microcontroller that communicates with various hardware and software sensors in the server to collect system information for monitoring the server. For example, the BMC may collect system information such as temperatures, CPU status (power, operating state, errors, temperature, etc.), software/firmware status (basic input/output system (BIOS) errors, operating system status, etc.), etc. The BMC may report the system information to the system administrator (or monitoring system), who can use the information to determine the health, operating state, etc. of the system. In addition, the BMC may cause the server to perform actions such as entering a sleep state, or resetting/power cycling the server (perhaps under the control of a system administrator or a monitoring system).

Although a BMC is useful for monitoring the server and causing the server to perform actions, the BMC is limited to a one-to-one configuration, in which each BMC is used to monitor a single server system (with a single processor, chipset, etc.). As systems progress toward high-density applications with multiple servers connected to a backplane, requiring a BMC to monitor each server system increases the cost and complexity of the system.

### SUMMARY

The described embodiments comprise a system management controller that manages servers on a plurality of sled devices. In some embodiments, the system management controller comprises a processing mechanism and a plurality of internal interfaces coupled to the processing mechanism. Each internal interface is configured to be coupled to each embedded management controller on a corresponding one of the sled devices, each embedded management controller facilitating communications between the processing mechanism and a corresponding server. In these embodiments, the processing mechanism is configured to manage one or more operations of the servers on the plurality of sled devices.

### BRIEF DESCRIPTION OF THE FIGURES

FIG. 1 presents a block diagram illustrating a system in accordance with some embodiments.

FIG. 2 presents a block diagram illustrating a server in accordance with some embodiments.

FIG. 3 presents a block diagram illustrating an embedded management controller in accordance with some embodiments.

FIG. 4 presents a block diagram illustrating buses coupled between a server and an embedded management controller in accordance with some embodiments.

FIG. 5 presents a block diagram illustrating a system management controller in accordance with some embodiments.

FIG. 6 presents a flowchart illustrating a process for performing management functions in an embedded management controller on a sled device in accordance with some embodiments.

FIG. 7 presents a flowchart illustrating a process for performing management functions in a system management controller in accordance with some embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

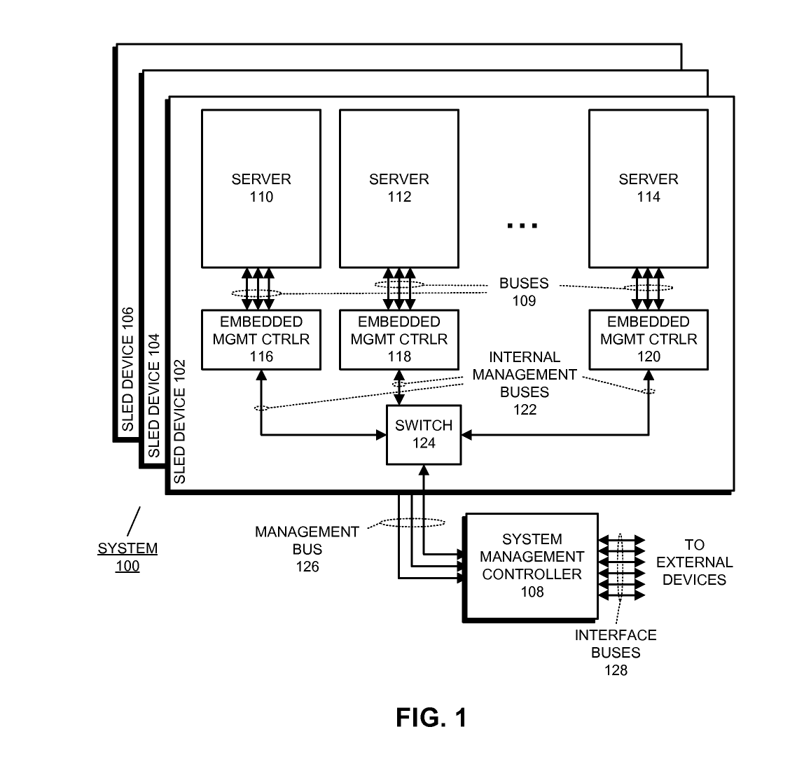

In some embodiments, a computing device (e.g., system 100 (see FIG. 1), servers 110-114, embedded management controller 116-120, system management controller 108, etc.) uses code and/or data stored on a computer-readable storage medium to perform some or all of the operations herein described. More specifically, the computing device reads the code and/or data from the computer-readable storage medium and executes the code and/or uses the data when performing the described operations.

A computer-readable storage medium can be any device or medium or combination thereof that stores code and/or data for use by a computing device. For example, the computer-readable storage medium may include, but is not limited to, volatile memory or non-volatile memory, including flash memory, random access memory (eDRAM, RAM, SRAM, DRAM, DDR, DDR2/DDR3/DDR4 SDRAM, etc.), read-only memory (ROM), and/or magnetic or optical storage mediums (e.g., disk drives, magnetic tape, CDs, DVDs). In the described embodiments, the computer-readable storage medium does not include non-statutory computer-readable storage mediums such as transitory signals.

In some embodiments, one or more hardware modules are configured to perform the operations herein described. For example, the hardware modules can comprise, but are not limited to, one or more processors/processor cores/central processing units (CPUs), application-specific integrated circuit (ASIC) chips, field-programmable gate arrays (FPGAs), caches/cache controllers, embedded processors, microcontrollers, graphics processors (GPUs)/graphics processor cores, pipelines, and/or other programmable-logic devices. When such hardware modules are activated, the hardware modules perform some or all of the operations. In some embodiments, the hardware modules include one or more general-purpose circuits that are configured by executing instructions (program code, microcode/firmware, etc.) to perform the operations.

In some embodiments, a data structure representative of some or all of the structures and mechanisms described herein (e.g., system 100, embedded management controllers 116-120, system management controller 108, and/or some portion thereof) is stored on a computer-readable storage medium that includes a database or other data structure which can be read by a computing device and used, directly or indirectly, to fabricate hardware comprising the structures and mechanisms. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates/circuit elements from a synthesis library that represent the functionality of the hardware comprising the above-described structures and mechanisms. The netlist may then be placed and routed to produce a data set describing geometric shapes to be applied to masks. The masks may then be used in various semiconductor fabrication steps to produce a semiconductor circuit or circuits corresponding to the above-described structures and mechanisms. Alternatively, the database on the computer accessible storage medium may be the netlist (with or without the synthesis library) or the data set, as desired, or Graphic Data System (GDS) II data.

In the following description, functional blocks may be referred to in describing some embodiments. Generally, functional blocks include one or more interrelated circuits that perform the described operations. In some embodiments, the circuits in a functional block include circuits that execute program code (e.g., application code, machine-language code, firmware, etc.) to perform the described operations.

### Overview

The described embodiments include a system with one or more sled devices (e.g., backplanes, motherboards, etc.), each sled device being coupled to a number of server nodes (or “servers”) in a high-density arrangement. Each server on the sled devices is coupled to a corresponding embedded management controller on the sled device that is configured to perform a first subset of a set of management functions for managing server operations. The embedded management controllers on each sled device are coupled to a system management controller that is configured to perform a second subset of the set of management functions.

In some embodiments, the first subset of management functions performed by the embedded management controllers generally includes “lightweight” or simpler management functions such as receiving communications from the server and storing data from the communications, providing responses to certain types of communication from the server, handling requests from the system management controller, etc., while the second subset of management functions performed by the system management controller comprises more complex management functions, such as management functions that call for more advanced analysis of data, communication with various external devices, controlling the operation of multiple servers on a sled device and/or multiple sled devices, etc. Thus, in some embodiments, the set of management functions is divided between the embedded management controller and the system management controller, with the embedded management controller performing a limited number of the set of management functions, and the system management controller performing the remainder of the set of management functions.

In some embodiments, each embedded management controller is a lower-performance processing device such as an application specific integrated circuit (ASIC), a field programmable gate array (FPGA), or a simplified embedded-class processor that is specifically configured to perform the first subset of the management functions, and the system management controller is a higher-performance processing device such as a microprocessor or a more fully-featured embedded-class processor that performs the second subset of the management functions.

In some embodiments, a separate set of buses is coupled between each server and the corresponding embedded management controller (i.e., the buses coupled to one server are not also coupled to the other servers). Each set of buses generally includes buses for communicating between the corresponding server and the embedded management controller to enable the above-described operations. For example, in some embodiments, the set of buses includes a general purpose input-output (GPIO) bus, an inter-integrated circuit (I²C) bus and/or system management bus (SMBus), and a low pin count (LPC) bus. The buses are used for collecting system information from the corresponding server and for communicating with the server to cause the server to perform actions (as is described in more detail below).

In some embodiments, a separate internal management bus is coupled between each embedded management controller and a switch on each sled device, and a single management bus is coupled between an output of the switch and the system management controller. In these embodiments, when a communication is received from the system management controller destined for an embedded management controller on the sled device, the switch receives the communication from the system management controller on the single management bus and forwards the communication to an appropriate embedded management controller using the internal management bus between the switch and the embedded management controller. When a communication is received from an embedded management controller on the sled device that is destined for the system management controller, the switch receives the communication from the embedded management controller on the corresponding internal management bus and forwards the communication to the system management controller on the single management bus. In this way, an interface between each sled device and the system management controller is limited to a single management bus for each sled, which simplifies wiring and the sending and receiving circuits in the system management controller.

In some embodiments, each embedded management controller, in concert with the system management controller, is configured to handle communications with the corresponding server so that the embedded management controller appears to the corresponding server to be a separate endpoint for each of the set of buses that is coupled between each server and the embedded management controller. In other words, in these embodiments, the embedded management controller behaves in such a way (e.g., responds to communications, sends commands/requests, etc.) that the servers are unaware that they are communicating with and receiving commands/requests from the embedded management controller and/or the system management controller. For example, assuming that a heartbeat signal is expected by the server on one of the set of buses that is coupled between the server and the corresponding embedded management controller, the embedded management controller (potentially at the request of the system management controller), may provide the heartbeat signal.

By using the embedded management controllers and the system management controller to manage multiple sled devices with multiple servers, the described embodiments enable the collection of information and management of the multiple servers without requiring, as in existing systems, a separate and complete baseboard management controller (BMC) for each server. The described embodiments therefore reduce the complexity of the management system for the servers when compared to existing systems, including reducing the number or complexity of integrated circuit chips that are required in the computing device, the amount of routing, the amount of power consumed by the management system, etc. In addition, the embedded management controller and system management controller are configured to communicate with each server so that the server sees the embedded management controller as an endpoint for the corresponding buses, meaning that the server can continue to use existing operating systems, drivers, applications, BIOS, etc. Moreover, the system management controller in the described embodiments can perform management functions for multiple sled devices and thus for the server(s) on each sled device, enabling inter-sled functions (load balancing, heat limiting, etc.) to be performed by the system management controller.

### Set of Management Functions

In this description, an embedded management controller is described that performs a first subset of a set of management functions for a given server and a system management controller is described that performs a second subset of the set of management functions for each server in a set of servers, including the given server. Generally, the set of management functions may include any management function that is performed to monitor, configure, control, update, or otherwise manage the server(s). For example, in some embodiments, the set of management functions comprises receiving reporting messages from one or more of the servers that indicate an operating state of the server (e.g., temperature, throughput, errors, events, etc.) and responding to reporting messages for which the servers expect a response. As another example, in some embodiments, the set of management functions comprises monitoring system state (e.g., workload, temperature, etc.) of one or more of the servers. As yet another example, in some embodiments, the set of management functions comprises causing the one or more of the servers to perform an action such as power-cycling/resetting, entering a lower-power or higher-power state, halting or commencing processing, etc. As yet another example, in some embodiments, the set of management functions comprises performing configuration operations to configure one or more of the servers.

In some embodiments, the first and second subsets of the management functions are mutually exclusive, with the embedded management controller performing “lightweight” or simpler tasks and the system management controller performing more complex tasks. For example, in some embodiments, the first subset of management functions performed by the embedded management controllers generally includes functions such as receiving communications from the server and storing data from the communications, providing responses to certain types of communication from the server, handling requests from the system management controller, etc. As another example, in some embodiments, the second subset of management functions performed by the system management controller comprises more complex management functions, such as management functions that call for more advanced analysis of data, communication with various external devices, controlling the operation of multiple servers on a sled device and/or multiple sled devices, etc. Note however, that, in some embodiments, mutual exclusion of management functions is not required and/or the management functions are apportioned differently. Thus, in the described embodiments, any division of management functions may be used.

In some embodiments, in order to perform the second subset of the management tasks, the system management controller may communicate with the embedded management controller to cause the embedded management controller to return information associated with the corresponding server or to cause the embedded management controller to send a command/request to the server to get the server to perform an action (e.g., change power state, change operating mode, reset, report server system information/data, etc.). For example, assuming that the embedded management controller collects and stores temperature data for from the corresponding server, the system management controller may send a request to the embedded management controller for the temperature data. The system management controller can then use the temperature data for performing other operations, such as trigging thermal alarms, scheduling jobs on servers, powering down servers, etc. As another example, the system management controller can send a communication to the embedded management controller that includes a command to place a corresponding server in a lower-power operating mode. The embedded management controller may then send a communication to the corresponding server to cause the server to enter the lower-power operating mode.

In some embodiments, the embedded management controller may pass requests/commands that are sent from the system management controller to the corresponding server without processing the request/command (aside from possibly determining a bus upon which to send the request/command to the server). In other words, for some requests/commands are simple “pass-through requests,” which are passed through the embedded management controller without otherwise processing the request (e.g., interpreting the request, forming a new packet from the requests, etc.). For example, a command to power-cycle the server may be received on a management bus from the system management controller and simply passed through to the server on an appropriate bus by the corresponding embedded management controller.

### System

FIG. 1 presents a block diagram illustrating a system 100 in accordance with some embodiments. As shown in FIG. 1, system 100 includes sled devices 102-106 and system management controller 108. Sled device 102 comprises a number of server nodes (or “servers”) 110-114 coupled via buses 109 to corresponding embedded management controllers 116-120 (“embedded mgmt ctrlr” in FIG. 1). Embedded management controllers 116-120 are each coupled via a corresponding separate internal management bus 122 to switch 124. Switch 124 is coupled via management bus 126 to system management controller 108. Note that, for clarity, details are shown only for sled device 102 in FIG. 1, however, sled devices 104-106 may comprise devices similar to sled device 102. Generally, each of the sled devices 102-106 comprises devices (e.g., servers and corresponding embedded management controllers, etc.) that are configured to perform the operations herein described.

Sled devices 102-106 comprise devices such as backplanes, motherboards, active or passive interposers, mechanical mounts, forms/molds, etc. to which the illustrated devices are mechanically fastened (e.g., plugged into sockets, soldered, held with clamps/fasteners, etc.). For example, in some embodiments, at least one of the sled devices is a high-density server backplane with a number of packaged integrated circuit chips and discrete components for the illustrated devices attached to the backplane using sockets, soldering, and/or other attachment techniques. In these embodiments, some or all of buses 109, internal management buses 122, and an on-board portion of management bus 126 may be implemented as circuit traces within the backplane that are coupled to the devices on the backplane as shown. In addition, in some embodiments, the backplane includes external connectors or plugs for connecting the circuit traces to external devices (such as system management controller 108). In some embodiments, sled devices 102-106 are included in frames/chassis (e.g., as server blades) configured to be mounted in a rack.

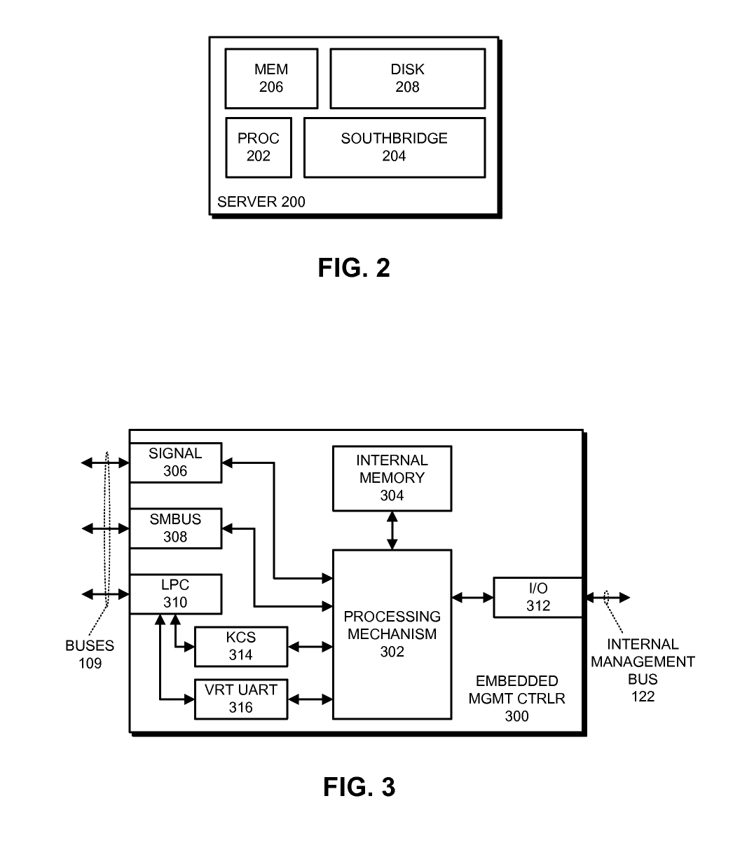

Servers 110-114 (which are interchangeably called “server nodes” or “nodes”) are separate servers that each comprise devices, functional blocks, and circuits for performing computational operations. FIG. 2 presents a block diagram illustrating a server 200 in accordance with some embodiments (servers 110-114 may have, but are not required to have, an internal arrangement similar to server 200). As can be seen in FIG. 2, server 200 includes processor (“proc”) 202, Southbridge controller hub 204 (“Southbridge”), memory 206 (“MEM”), and disk 208. Processor 202 comprises one or more integrated circuit chips with one or more computational mechanisms and/or functional blocks (CPUs/processors, GPUs, Accelerated Processing Units (APUs,) processor cores, pipelines, etc.) configured to perform computational operations for server 200.

Southbridge controller hub 204 comprises one or more integrated circuit chips in a logic chipset of server 200 that is/are responsible for handling communication (inputs to and outputs from server 200) on relatively slower interfaces such as a general purpose input-output (GPIO) bus, an inter-integrated circuit (I²C) bus and/or system management bus (SMBus), and a low pin count (LPC) bus. In some embodiments, Southbridge controller hub 204 works in combination with a Northbridge controller hub (which is not shown, but which may be coupled between processor 202 and Southbridge controller hub 204), and the Northbridge controller hub handles communications on relatively faster interfaces such as the interface between memory 206 and processor 202.

Memory 206 and disk 208 are computer-readable storage mediums used for storing instructions and data that are used by devices in server 200 (e.g., processor 202, etc.) for performing operations. Memory 206 comprises memory circuits (e.g., one or more of DRAM, SRAM, DDR SDRAM, and/or other types of memory circuits) that form a “main memory” of server 200. Disk 208 is a mass-storage device such as a one or more non-volatile semiconductor memories (flash, phase-change memory, etc.) and/or disk drives. Taken together, memory 206 and disk 208, along with any caches in server 200, form a “memory hierarchy” in and for server 200. Each of the caches, memory 206, and disk 208 are regarded as levels of the memory hierarchy, with the lower levels including memory 206 and disk 208.

In some embodiments, although not shown in FIG. 2, server 200 further comprises a number of hardware sensors (e.g., temperature sensors, timers, vibration/sound sensors, etc.) and software sensors (e.g., monitoring subroutines in an operating system on server 200, applications/daemons, microcode/firmware applications, BIOS routines, etc.) that are used to collect system information from server 200 that is to be communicated to a corresponding embedded management controller using messages/signals on buses 109, as described herein.

Although server 200 is presented in FIG. 2 using certain subsystems (i.e., processor 202, Southbridge controller hub 204, etc.), server 200 has been simplified for the purpose of this description. In some embodiments, server 200 comprises more or fewer subsystems. For example, server 200 may include subsystems such as power supplies/controllers, fans, batteries, media processors, input-output mechanisms and devices, communication mechanisms, networking mechanisms, display mechanisms, etc. Generally, server 200 includes sufficient devices to perform the operations herein described.

In addition, although three servers are shown in FIG. 1, in some embodiments (as represented by the ellipsis in FIG. 1), a different number of servers may be included. For example, in some embodiments, 1, 4, 8, 15, or another number of servers is coupled to each sled device (and the number of servers on each of sled devices 102-106 need not be the same). Generally, the described embodiments may have any number of servers on each sled device.

Embedded management controllers 116-120 are lower-performance processing devices such as ASICs, FPGAs, or simplified embedded-class processors that are configured to perform a first subset of a set of management functions for servers 110-114, respectively. FIG. 3 presents a block diagram illustrating embedded management controller 300 in accordance with some embodiments (embedded management controllers 116-118 may have, but are not required to have, an internal arrangement similar to embedded management controller 300). As shown in FIG. 3, embedded management controller 300 includes processing mechanism 302 and internal memory 304. Processing mechanism 302 is coupled to the signal 306, SMBus 308, and LPC 310 interfaces, as well as the input-output (“I/O”) 312 interface. The LPC 310 interface includes a keyboard controller style 314 (“KCS”) and virtual universal asynchronous receiver/transmitter (“VRT UART”) 316 interface.

Processing mechanism 302 comprises one or more computational mechanisms and/or functional blocks configured to perform computational operations for embedded management controller 300. As described above, in some embodiments, processing mechanism 302 is a computational mechanism or functional block with limited processing power. For example, processing mechanism 302 may include dedicated or purpose-built circuits that are configured for performing the first subset of the management functions efficiently, but are not configured to perform more generalized computational operations. In this way, processing mechanism 302 (and hence embedded management controller 300 generally) can be physically smaller and consume less power than a more fully-featured processor such as a fully-featured embedded processor or a processor core.

Internal memory 304 comprises memory circuits (e.g., one or more of DRAM, SRAM, DDR SDRAM, and/or other types of memory circuits) used for storing instructions and data that are used by devices in embedded management controller 300 (e.g., processing mechanism 302, etc.) for performing operations. In some embodiments, when a communication is received from a server 200 in embedded management controller 300, information from the communication is saved in internal memory 304. The information can then be retrieved from internal memory 304 and used for operations in embedded management controller 300 (such as providing a response to the communication, should a response be expected by server 200) and/or used to satisfy a request for information associated with the server 200 from system management controller 108. For example, if the communication from server 200 includes information about a BIOS error that occurred in server 200, the information about the BIOS error can be saved in internal memory 304 and subsequently retrieved to be sent to system management controller 108 in response to a request for information associated with the server 200 from system management controller 108.

Each of the signal 306, SMBus 308, and LPC 310 interfaces in embedded management controller 300 comprise interface circuits (e.g., signal line drivers, receivers, processing circuits, etc.) and/or software that are used to transmit communications to and receive communications from a corresponding server 200. For example, in some embodiments, the interfaces can be used to communicate server status information from server 200 to embedded management controller 300, and to communicate requests and/or commands from embedded management controller 300 to server 200. For instance, in some embodiments, the signal 306 interface comprises a GPIO interface that is used to communicate commands/requests for controlling the power state of server 200 and/or resetting server 200, communicate timer information (possibly for timers maintained by embedded management controller 300 and/or system management controller 108 for the server 200), communicate interrupts to server 200, and/or communicate a presence signal from server 200 to embedded management controller 300 (or vice versa). As another example, in some embodiments, the SMBus 308 interface is used to communicate information about the operating status/state/functions of processor 202 in server 200 (e.g., hardware sensor outputs and/or other physical state values, software sensor outputs and other software state values, etc.). As yet another example, in some embodiments, the LPC 310 interface is used for communicating system events such as errors, operating messages, etc. from server 200 to embedded management controller 300.

In some embodiments, the LPC 310 interface includes the keyboard controller style 314 and virtual UART 316 interfaces. The keyboard controller style 314 and virtual UART 316 interfaces are used for communicating with server 200 using the associated protocols. For example, in some embodiments, the keyboard controller style 314 interface is used for communicating with a BIOS on server 200, and the virtual UART is provided by the LPC 310 interface to be used for serial communications with server 200.

The input-output 312 interface comprises interface circuits (e.g., signal line drivers/receivers, processing circuits, etc.) and/or software that are used to transmit communications to and receive communications from switch 124 on internal management bus 122 (and, via switch 124, to and from system management controller 108). For example, in some embodiments, the input-output 312 interface can be used to communicate server status information from embedded management controller 300 (which was received from server 200) to switch 124, and to communicate requests and/or commands from switch 124 (which were received from system management controller 108) to embedded management controller 300 on internal management bus 122.

Any of a number of different protocols may be used for communicating on internal management bus 122 and management bus 126, depending on the configuration of system 100. For example, in some embodiments, the I²C protocol is used for communicating on internal management bus 122 and management bus 126. Thus, in these embodiments, the input-output 312 interface is configured with appropriate signal line drivers/receivers, processing circuits, etc. for communicating on internal management bus 122 using the I²C protocol. As another example, in some embodiments, the Ethernet protocol is used for communicating on internal management bus 122 and management bus 126. Thus, in these embodiments, the input-output 312 interface is configured with appropriate signal line drivers/receivers, processing circuits, etc. for communicating on internal management bus 122 using the Ethernet protocol.

As described above, in some embodiments, processing mechanism 302 is configured to receive communications from server 200 on interfaces 306-310 and save information from the communications in internal memory 304. The saved information can then be retrieved from internal memory 304 and used to generate a frame/packet in accordance with the protocol that is used for communicating on internal management bus 122 (e.g., I²C, Ethernet, etc.). The frame/packet is then transmitted to switch 124 on internal management bus 122 and, via switch 124, to system management controller 108. In addition, a frame/packet may be received from switch 124 on internal management bus 122 (the frame/packet having been transmitted by system management controller 108). Processing mechanism 302 may then process the frame/packet to determine if the frame/packet contains a request for data and/or a command/request for server 200, and handle the request for data and/or command request for server 200 accordingly. In these embodiments, therefore, embedded management controller 300 serves as a translation mechanism between the protocols used for buses 109 and the protocol used for internal management bus 122. This translation function enables server 200 to use expected/traditional interfaces for communicating with embedded management controller 300, but simplifies communication between embedded management controller 300 and system management controller 108 (e.g., reduces the amount of routing, the complexity of interface circuits, etc.). The use of expected/traditional interfaces for server 200 means that established software and hardware in server 200 that were developed for communicating between server 200 and a dedicated BMC may continue to be used, although the BMC has been replaced with the devices/mechanisms herein described.

As described above, in some embodiments, the first subset of management functions performed by embedded management controller 300 comprises “lightweight” or simpler management functions such as communicating with server 200 to collect information from server 200. For example, processing mechanism 302 in embedded management controller 300 may collect information such as device temperatures, memory system or disk drive statistics (I/O throughput, memory access speeds, etc.), CPU status (power mode, operating state, errors, performance/throughput, etc.), software/firmware status (basic input/output system (BIOS) errors, application/operating system status/events, etc.), and/or other information. Processing mechanism 302 may then store the collected information in internal memory 304. In some embodiments, the communications can be triggered by hardware or software on server 200 without a request from embedded management controller 300 (e.g., reporting temperature data, a hardware and/or software event report, etc.), or can be made in response to a request by processing mechanism 302 in embedded management controller 300.

As another example of the management functions from the first set of management functions performed by embedded management controller 300, in some embodiments, processing mechanism 302 receives requests from system management controller 108 and handles the requests. For example, processing mechanism 302 may receive a request from system management controller 108 for information associated with server 200, and may send information collected from server 200 (as described above) to system management controller 108 to satisfy the request. For example, assuming that the information is an operating temperature of some portion of server 200 (CPU, disk drive, etc.), processing mechanism 302 may (e.g., periodically, on request, etc.) receive temperature data from server 200 and may store temperature data in internal memory 304. Processing mechanism 302 may then respond to a request from system management controller 108 with some or all of the temperature data. As another example, processing mechanism 302 may receive a request from system management controller 108 to place server 200 in a lower-power or higher-power operating mode. Processing mechanism 302 may then forward the request to server 200 (thereby functioning as a “pass through” for the request) and/or may otherwise communicate with server 200 to place server 200 in the lower-power or higher-power operating mode.

In some embodiments, embedded management controller 300 is configured so that a package in which embedded management controller 300 is contained (and thereby coupled to a sled device) is minimally-sized. In these embodiments, an integrated circuit chip upon which embedded management controller 300 is fabricated can be arranged (via optimized circuit/device design and layout, optimized routing, etc.) so that the circuits that perform the first subset of the management functions are laid out in a smaller amount of physical die area. For example, the integrated circuits may include circuits/devices/routing for performing the indicated management functions efficiently, and may not include superfluous circuits/devices/routing. In some of these embodiments, the package that contains embedded management controller 300 is approximately 7 mm in length and 7 mm in width.

Although embedded management controller 300 is presented in FIG. 3 using certain subsystems (i.e., processing mechanism 302, the interfaces, etc.), in some embodiments, embedded management controller 300 comprises different and/or additional subsystems. Generally, embedded management controller 300 can includes sufficient devices to perform the operations herein described.

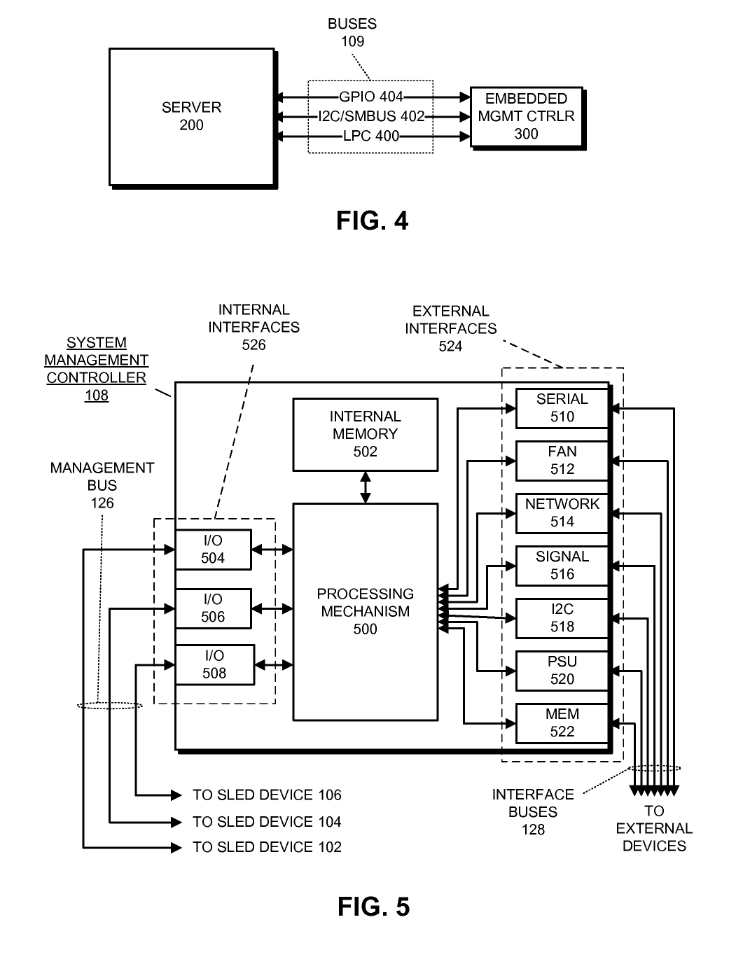

Returning to FIG. 1, buses 109 comprise signal lines (e.g., wires, traces in a circuit board, waveguides, etc.) that are used to carry communications between each of servers 110-114 and a corresponding embedded management controller 116-120. FIG. 4 presents a block diagram illustrating buses 109 coupled between a server 200 (which, as described above, may be any one of servers 110-114) and an embedded management controller 300 (which is a corresponding one of embedded management controllers 116-120) in accordance with some embodiments. As can be seen in FIG. 4, buses 109 comprise an LPC 400 bus, a I²C/SMBus 402 bus, and a GPIO 404 bus. In the embodiments shown in FIG. 4, the I²C/SMBus 402 bus is listed as such to illustrate that, in some embodiments, the bus may be an I²C bus and/or an SMBus bus; thus, these embodiments may use both standards for communicating on the bus or may only use one of the standards. In these embodiments, the LPC 400 bus, the I²C/SMBus 402 bus, and the GPIO 404 bus are coupled to the LPC 310, SMBus 308, and signal 306 interfaces in embedded management controller 300, respectively, and may be used for exchanging the communications/information described above for the LPC 310, SMBus 308, and signal 306 interfaces.

Buses 109 as shown in FIG. 4 represents a copy of the three buses that are separately coupled between each of servers 110-114 and embedded management controller 116-120 (i.e., each set of buses coupled between a server and an embedded management controller in FIG. 1 comprises the buses shown in FIG. 4). Thus, between server 110 and embedded management controller 116, there is a separate LPC 400 bus, I²C/SMBus 402 bus, and GPIO 404 bus, and the same is true between server 112 and embedded management controller 118 and server 114 and embedded management controller 120.

In some embodiments, one or more of the buses in buses 109 comprises multiple individual signal lines. For example, in some embodiments the GPIO 404 bus comprises 12, 10, or another number of signal lines, each of which may be assigned for some type of communication between the corresponding server 200 and embedded management controller 300. Generally, there are sufficient signal lines for communicating the described signals and information between server 200 and embedded management controller 300.

Switch 124 includes circuits for routing communications between embedded management controllers 116-120 and system management controller 108. For example, in some embodiments, the input-output 312 interface of each of embedded management controllers 116-120 is associated with a unique identifier (e.g., port number, address, etc.), as is system management controller 108. In these embodiments, when a communication is to be exchanged between one of embedded management controllers 116-120 and system management controller 108, switch 124 routes the communication based on the unique identifier. In some embodiments, a different technique (dedicated signal line, etc.) is used to indicate to switch 124 the destination for a communication.

Management bus 126 comprises signal lines (e.g., wires, traces in circuit boards, waveguides, etc.) that are used to carry communications between each of the sled devices and system management controller 108. Recall that the sled devices in some embodiments are backplanes, motherboards, active or passive interposers, mechanical mounts, forms/molds, etc.; in these embodiments, system management controller 108 may be located on a remote backplane, mechanical mount, system, etc., and may therefore be coupled to the sled devices using one or more plugs, etc., through which management bus 126 traverses.

System management controller 108 is higher-performance processing device such as a microprocessor or a more fully-featured embedded-class processor that is configured to perform a second subset of the set of management functions for servers 110-114. FIG. 5 presents a block diagram illustrating system management controller 108 in accordance with some embodiments. As shown in FIG. 5, system management controller 108 comprises processing mechanism 500 and internal memory 502. Processing mechanism 500 is coupled to a set of internal interfaces 526, which include the input/output (“I/O”) 504-508 interfaces, as well as to a set of external interfaces 524, which include the serial 510, FAN 512, network 514, signal 516, I²C 518, PSU 520, and MEM 522 interfaces.

Processing mechanism 500 comprises one or more computational mechanisms and/or functional blocks configured to perform computational operations for system management controller 108. In contrast to embedded management controller 300 (which, as described above, can be any of embedded management controller 116-120), in which processing mechanism 302 has limited processing power, processing mechanism 500 has more processing power and can therefore perform more varied and complex operations. For example, processing mechanism 500 can be a more fully-featured embedded processor, a CPU or processor core, etc. In some embodiments, a set of processing circuits in processing mechanism 500 comprises general-purpose processing circuits that can be configured using program code/instructions to perform a large variety of operations.

Internal memory 502 comprises memory circuits (e.g., one or more of DRAM, SRAM, DDR SDRAM, and/or other types of memory circuits) used for storing instructions and data that are used by devices in system management controller 108 (e.g., processing mechanism 500, etc.) for performing operations. For example, internal memory 502 may be used to store firmware that executes on processing mechanism 500, data received from embedded management controllers 116-120 or external devices, etc.

Each of the input-output 504-508 interfaces in internal interfaces 526 comprise interface circuits (e.g., signal line drivers, receivers, processing circuits, etc.) and/or software that are used to transmit communications to and receive communications from a corresponding sled device 102-106 on management bus 126. For example, the input-output 504 interface is used for exchanging communications between sled device 102 and system management controller 108. In some embodiments, transmitting communications from system management controller 108 to a sled device using a corresponding input-output interface comprises transmitting requests and commands for a particular server that are handled by a corresponding embedded management controller on the sled device. For example, for a request for information associated with server 110 on sled device 102, system management controller 108 sends the request to embedded management controller 116, which then responds with the information associated with server 110 (or another response, e.g., an error response). As another example, when sending a command for (or a request for an action to be performed by) server 110 on sled device 102, system management controller 108 sends the command to embedded management controller 116 via the input-output 504 interface. Embedded management controller 116 then either forwards the command to server 110 on the appropriate bus from buses 109 (thereby functioning as a “pass-through” for the command) or otherwise communicates with server 110 to cause server 110 to execute the command or perform the action. As described above, executing the command or performing the action can include executing any command or performing any action to monitor, configure, control, update, and/or otherwise manage the server 110. For example, the command can cause server 110 to change power state, change operating mode, reset, report various server system information/data, etc. As yet another example, system management controller 108 may receive information associated with server 110 from embedded management controller 116 and save the received information in internal memory 502, from where processing mechanism 500 may use the information for performing computations, or may report the information to an external device using one of the external interfaces (as described below).

As described above, any of a number of different protocols may be used for communicating management bus 126, depending on the configuration of system 100. For example, in some embodiments, the I²C protocol is used for communicating on management bus 126. Thus, in these embodiments, the input-output 504-508 interfaces are configured with appropriate signal line drivers/receivers, processing circuits, etc. for communicating on management bus 126 using the I²C protocol. As another example, in some embodiments, the Ethernet protocol is used for communicating on management bus 126. Thus, in these embodiments, the input-output 504-508 interfaces are configured with appropriate signal line drivers/receivers, processing circuits, etc. for communicating on management bus 126 using the Ethernet protocol.

When a request or command is sent from system management controller 108 on management bus 126 to sled device 102 (or another of the sled devices), the request or command is included within a frame/packet that is transmitted from the corresponding interface on management bus 126 in accordance with the protocol used for management bus 126. The frame/packet containing the request or command is then received in sled device 102 by switch 124. Switch 124 then uses an indication of a destination embedded management controller associated with the packet to determine the destination embedded management controller (and hence the server to which the command or request is directed) and forwards the frame/packet accordingly.

As a group, external interfaces 524 include interface circuits (e.g., signal line drivers, receivers, processing circuits, etc.) and/or software that can be used to communicate from system management controller 108 to external devices. For example, one or more of the external interfaces 524 may be used to communicate information associated with a server (e.g., hardware/software events, temperatures, alarms, errors, configuration information, etc.) to a system administrator or a monitoring system. As another example, one or more of the external interfaces may enable another device to communicate commands such as configuration settings and updates to system management controller 108, from where they may be communicated (via management bus 126, switch 124, etc.) to one or more of the sled devices to cause embedded management controller(s) on the sled devices to cause the corresponding servers to perform an associated action. The external devices may comprise any number or arrangement of devices, including equipment (routers, switches, etc.) for communicating on a network, monitoring systems, displays, external memories, power supply units, hand-held devices, fan controllers, other system management controllers, etc. with which the system management controller 108 can communicate while performing the management functions described herein using one or more of the external interfaces 524.

As shown in FIG. 5, the external interfaces 524 comprise the serial 510, fan controller 512 (“FAN”), network 514, signal 516, I²C 518, power supply unit 520 (“PSU”), and memory 522 (“MEM”) interfaces. The serial 510 interface includes hardware devices and/or software that may be used for serial communications with external devices such as via UART, universal serial bus (USB), IEEE 1394, etc. The fan controller 512 interface includes hardware devices and/or software that may be used to communicate with one or more fan controllers to control operating speeds of fans (not shown) in system 100, including fan controllers that control fans on sled devices 102-106, etc. The network 514 interface can include hardware devices and/or software that may be used for communicating on a wired network such as an Ethernet network and/or a wireless network such as a Bluetooth network, an IEEE 802.11 network, etc. The signal 516 interface includes hardware devices and/or software for communicating on a bus such as a GPIO bus, for communicating on dedicated signal lines (e.g., for controlling and/or receiving signals from front panel lights, buttons, etc. in system 100). The I²C 518 interface includes hardware devices and/or software for communicating on an external I²C bus, including for possibly receiving signals from sensors, transducers, etc. located in portions of system 100 that are not shown in FIG. 1 (temperature sensors, vibration sensors, etc.). The power supply unit 520 interface includes hardware devices and/or software that are used for sending signals to and receiving signals from one or more power supply units associated with system 100. The memory 522 interface includes hardware devices and/or software that are used for sending information to and retrieving information from an external memory (not shown in FIG. 1) in system 100, e.g., a DDR memory for storing logs of information associated with the server, events from system management controller 108 and/or one of the embedded management controllers, program code/firmware, etc.

As described above, in some embodiments, the second subset of management functions performed by the system management controller comprises more complex management functions, such as management functions that call for more advanced analysis of data, communication with various external devices, controlling the operation of multiple servers on a sled device and/or multiple sled devices, etc. For example, processing mechanism 500 may receive CPU or memory load information from some or all servers on the sled devices in the system and may determine an adjusted distribution of processing tasks based on the load information (e.g., may shift tasks or assign new tasks to less-loaded servers from among the servers). As another example, based on an analysis of the temperature of one or more servers on the sled devices, processing mechanism 500 may cause one or more of the servers to transition to a lower-power or higher-power operating mode and/or may cause a fan's speed to be increased or decreased. As yet another example, processing mechanism 500 may selectively report information (e.g., filter out selected events before reporting, etc.) associated with servers on one or more of the sled devices to a system administrator (or monitoring system) via the serial 510 interface, the network 514 interface, the signal 516 interface, etc. As yet another example, processing mechanism 500 may detect, via event information associated with a server on a sled device, that the server has reached an operating state where the server should be restarted and may send a command to the corresponding embedded management controller to cause the embedded management controller to restart the server (with or without input from external interfaces 524). As yet another example, processing mechanism 500 may request one or more types of information associated with one or more servers (e.g., device temperatures, memory system or disk drive statistics (I/O throughput, memory access speeds, etc.), CPU status (power mode, operating state, errors, performance/throughput, etc.), software/firmware status (basic input/output system (BIOS) errors, application/operating system status/events, etc.), and/or other information) from the corresponding embedded management controller, may use the requested information to determine the overall health of the servers, and may send an alert to a system administrator when one or more servers appears to be unhealthy (e.g., in imminent danger of crashing, etc.).

Although system management controller 108 is presented in FIG. 5 using certain subsystems (i.e., processing mechanism 500, the external interfaces, etc.), in some embodiments, system management controller 108 comprises different and/or additional subsystems. For example, in some embodiments, the external interfaces 524 may comprise more or fewer interfaces. Generally, system management controller 108 includes sufficient devices to perform the operations herein described.

As shown in FIGS. 1 and 5, system management controller 108 manages (i.e., performs the second set of management functions) for multiple sled devices. Thus, unlike in existing systems that use a single BMC for performing the management functions for a single corresponding server, in the described embodiments, embedded management controllers perform lightweight management functions for individual servers, and the system management controller 108 performs more complicated management functions for all of the servers on the sled devices.

### Processes for Managing Servers on Sled Devices

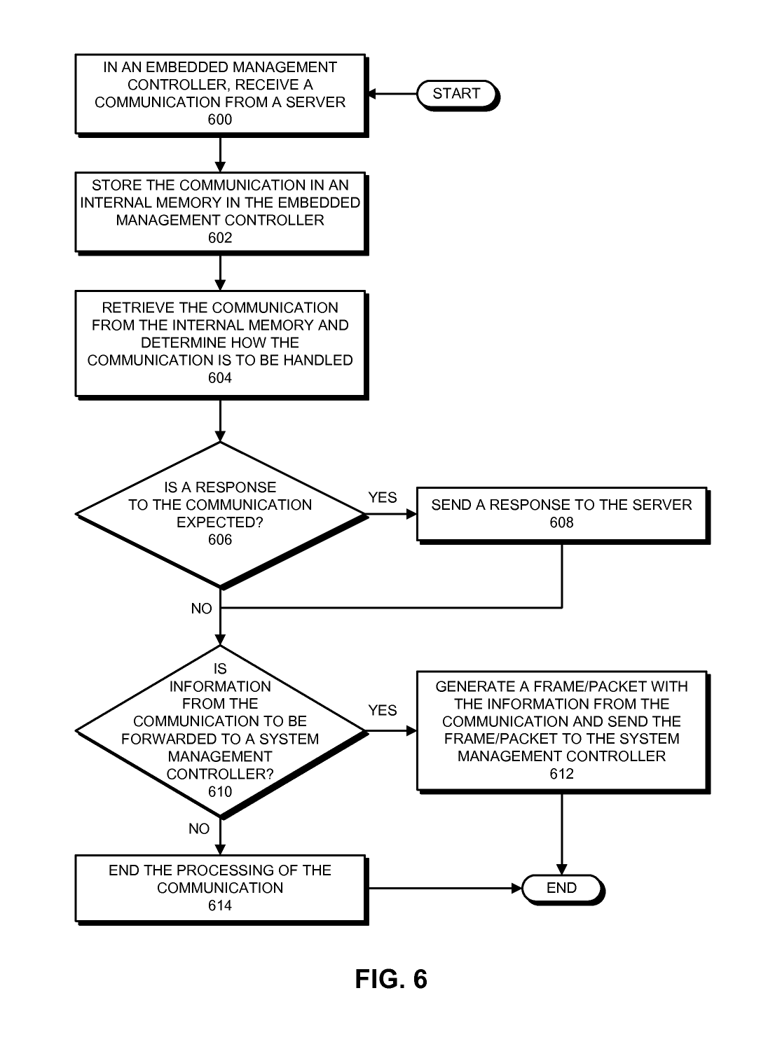

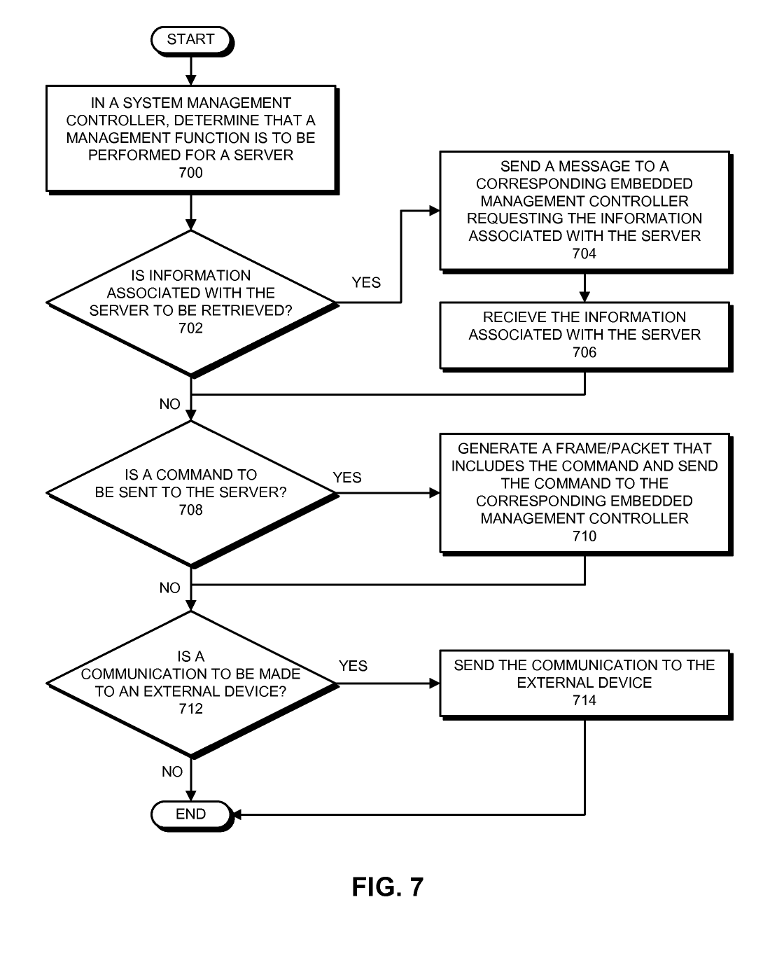

FIGS. 6 and 7 present flowcharts illustrating aspects of managing servers on sled devices using embedded management controllers and a system management controller in accordance with some embodiments. More specifically, FIG. 6 presents a flowchart illustrating a process for performing management functions in an embedded management controller on a sled device in accordance with some embodiments, and FIG. 7 presents a flowchart illustrating a process for performing management functions in a system management controller in accordance with some embodiments. Although presented in separate figures, as described above, in some embodiments, the system management controller and the embedded management controllers are used in combination to manage server operations.

The operations shown in FIGS. 6 and 7 are presented as a general example of functions performed by some embodiments. The operations performed by other embodiments include different operations and/or operations that are performed in a different order. Additionally, although certain mechanisms are used in describing the processes, in some embodiments, other mechanisms can perform the operations.

The process shown in FIG. 6 starts when embedded management controller 300 (which can be any of embedded management controllers 116-120 on sled device 102) receives a communication from a corresponding server 200 (which is a server that is managed by the embedded management controller) (step 600). For example, in some embodiments, the communication comprises an indication of a BIOS error, a PCI link speed notification, etc. that is received on the LPC 400 bus from server 200 via the LPC 310 interface. As another example, in some embodiments, the communication comprises CPU status information and is received on the I²C/SMBus 402 bus from server 200 via the SMBus 308 interface. As yet another example, in some embodiments, the communication comprises a presence signal received on the GPIO 404 bus from server 200 via the signal 306 interface. More generally, any communication that may be transmitted from server 200 to the embedded management controller 300 on the LPC 400 bus, the I²C/SMBus 402, and/or the GPIO 404 bus can be received in embedded management controller 300. In these embodiments, the communication can be in any format (packet, bit stream or pattern, etc.) used to transmit communications from server 200 to embedded management controller 300 (i.e., that server 200 can generate and that embedded management controller 300 can interpret).

In some embodiments, the communication can have been sent by server 200 in response to a request by embedded management controller 300 for information associated with server 200. For example, embedded management controller 300 may request temperature data, software or hardware operating status, etc. from server 200. In some embodiments, the communication can have been sent from server 200 without having received a request from embedded management controller 300. For example, server 200 may automatically report software or hardware errors or events, periodically report system status, etc. to embedded management controller 300.

Embedded management controller 300 then stores the communication in internal memory 304 (step 602). For example, embedded management controller 300 can extract information associated with server 200 from the communication (e.g., extract a payload, header, etc. from the communication) and can store the information associated with server 200 in internal memory 304. In some embodiments, the information associated with the server is extracted from the communication and stored to enable the subsequent generation of a frame/packet to be sent to system management controller 108 on internal management bus 122 via input-output interface 312 (recall that the protocol used on internal management bus 122 may differ from the protocols used to communicate information associated with server 200 from server 200 to embedded management controller 300).

Next, embedded management controller 300 retrieves the communication from internal memory 502 and processes the communication to determine how the communication is to be handled (step 604). In some embodiments, this operation comprises retrieving the communication along with zero or more other communications from server 200 from internal memory 502 and performing one or more computational operations such as communication rule lookups, table searches, filtering, format comparisons, content resolution, external entity lookups, etc. using the retrieved communication(s) to determine how the communication (and possibly the other communications) are to be handled.

If, during the processing of the communication, embedded management controller 300 determines that a response to the communication is expected by server 200 (step 606), embedded management controller 300 generates the response and sends the response to server 200 (step 608). For example, the communication from server 200 can be a heartbeat signal that is used by server 200 to ensure that embedded management controller 300 is present and functioning, and embedded management controller 300 can respond accordingly. As another example, server 200 may expect an acknowledgement of the safe/correct receipt of the communication, and embedded management controller 300 can send the acknowledgement. As yet another example, the communication from server 200 may set a timer (e.g., a watchdog timer) in embedded management controller 300, and embedded management controller 300 can send a timer-end signal to server 200 (e.g., when the timer eventually expires). Generally, embedded management controller 300 can respond to any of various types of communication for which server 200 expects a response.

Embedded management controller 300 next determines if information associated with server 200 from the communication is to be forwarded to system management controller 108 (step 610). For example, embedded management controller 300 can determine if the information associated with server 200 has been requested by system management controller 108 or if the information associated with server 200 is of a type (e.g., error or event messages, alerts, etc.) that is automatically reported to system management controller 108. If so, embedded management controller 300 generates a frame/packet that includes the information and sends the frame/packet to system management controller 108 on management bus 126 (step 612).

If controller 114 determines that the communication is not to be forwarded to system management controller 108 (step 610), embedded management controller 300 ends the processing of the communication (step 614).

Note that storing the information associated with the server, responding to communications, and sending information associated with server 200 to system management controller 108 as described above are examples of the management functions in the first subset of the set management functions that are performed by embedded management controller 300.

The process shown in FIG. 7 starts when system management controller 108 determines that a management function is to be performed for server 110 on sled device 102 (step 700). For example, system management controller 108 can determine that one or more temperatures of server 110 and possibly other servers are to be acquired to enable system management controller 108 to determine if server 110 is to be placed in a lower-power or higher-power operating mode. As another example, system management controller 108 can determine that a report of information associated with server 110 (operating status, load levels, and/or other information associated with server 110) is to be made to an external monitoring system. As yet another example, system management controller 108 may determine that server 110 is to be power-cycled or reset. More generally, system management controller 108 can determine that any of the second subset of management functions is to be performed.

In some embodiments, system management controller 108 determines that the management function is to be performed based on one or more inputs received from an external device. For example, a system administrator, via one or more of the external interfaces, may send a request to the system management controller 108 requesting a server load profile from system management controller 108, the server load profile including a listing of the present (and possibly past) load on one or more servers (including server 110). As another example, system management controller 108 may be configured to retrieve program code from an external memory using the memory 522 interface and execute the program code, the program code including instructions to perform the management function.

System management controller 108 then determines if information associated with server 110 is to be retrieved as part of performing the management function (step 702). For example, system management controller 108 can determine if one or more of e.g., device temperatures, memory system or disk drive statistics (I/O throughput, memory access speeds, etc.), CPU status (power mode, operating state, errors, performance/throughput, etc.), software/firmware status (basic input/output system (BIOS) errors, application/operating system status/events, etc.), and/or other information associated with server 110 is to be retrieved. If so, system management controller 108 sends a message to embedded management controller 116 (e.g., a frame/packet in the protocol used for transmitting messages on management bus 126) requesting the information associated with server 110 (step 704). Embedded management controller 116 may then respond with the information associated with server 110 (as described above in FIG. 6), which is subsequently received in system management controller 108 (step 706).

As described above, the message sent by system management controller 108 to embedded management controller 116 is initially received by switch 124 on sled device 102. Switch 124 determines that the message (which may be included in a frame/packet in the protocol used for transmitting messages on management bus 126) is destined for embedded management controller 116 and forwards the message accordingly. Similarly, when a frame/packet that includes a response is sent from embedded management controller 116, the frame/packet is routed to system management controller 108 by switch 124. Switch 124 generally performs these operations for all communications exchanged between system management controller 108 and the embedded management controllers.

Next, system management controller 108 determines if a command is to be sent to server 110 as part of performing the management function (step 708). For example, system management controller 108 can determine that a command for the server to reset or restart is to be sent to the server as part of performing the management function. If so, system management controller 108 generates a frame/packet that includes the command and sends the frame/packet to embedded management controller 116 (step 710). As described herein, the frame/packet may include a command that is to be forwarded to server 110 by embedded management controller 116 (i.e., a “pass-through” command) or may include a command that causes embedded management controller 116 to generate one or more commands to be sent to server 110.

In some embodiments, the management function to be performed by system management controller 108 includes both retrieving information associated with server 110 and sending a command to server 110. For example, system management controller 108 may retrieve loading information from server 110 (and possibly other servers on sled devices 102-106), and may then send a command to server 110 (and possibly other servers on sled devices 102-106) that causes server 110 to enter lower-power or higher-power operating mode, halt processing, reset, etc. based on the retrieved loading information.

Next, system management controller 108 determines of one or more communications are to be made with one or more external devices as part of performing the management function (step 712). For example, as part of performing the management function, system management controller 108 may alter the operating speed of one or more fans in system 100. As another example, system management controller 108 may retrieve operating state information from a power supply unit. As yet another example, system management controller 108 may send one or more communications on a network (e.g., to a system administrator or monitoring system). If so, system management controller 108 makes the communication with the external device (step 714).

The example shown in FIG. 7 is described using server 110 on sled device 102, however, in some embodiments, system management controller 108 may perform a similar process for managing servers 112 or 114 on sled device 102, or for managing a server on sled devices 104 or 106.

Note that retrieving the information, sending a command, and communicating with an external device as described above are examples of the management functions in the second subset of the set management functions that are performed by system management controller 108.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. An apparatus for managing servers on a plurality of sled devices, comprising:
a system management controller, comprising:
a processing mechanism; and
a plurality of internal interfaces coupled to the processing mechanism, each internal interface configured to be coupled to each embedded management controller on a corresponding one of the sled devices, each embedded management controller facilitating communications between the processing mechanism and a corresponding server;
wherein the processing mechanism is configured to manage one or more operations of the servers on the plurality of sled devices.

2. The apparatus of claim 1, wherein the processing mechanism is configured to:
request information associated with a server from a corresponding embedded management controller via a corresponding internal interface; and
receive a response including the information from the corresponding embedded management controller via the corresponding internal interface, wherein the information is acquired by the corresponding embedded management controller from the server.

3. The apparatus of claim 1, further comprising:
a plurality of external interfaces coupled to the processing mechanism, each external interface configured to be coupled to at least one external device.

4. The apparatus of claim 3, wherein the processing mechanism is configured to send one or more communications to one or more external devices using corresponding external interfaces.

5. The apparatus of claim 3, wherein the plurality of external interfaces coupled to the processing mechanism comprise one or more interfaces selected from the following group:
a serial interface;
a fan controller interface;
a network interface;
a front panel interface;
an inter-integrated circuit (I²C) interface;
a power supply interface; and
a memory interface.

6. The apparatus of claim 1, further comprising:
a memory coupled to the processing mechanism, wherein the memory is configured to store data and instructions for the processing mechanism.

7. The apparatus of claim 1, further comprising:
a bus coupled between all of the embedded management controllers on each of the sled devices and the corresponding internal interface on the system management controller.

8. The apparatus of claim 7, wherein the bus is an Ethernet bus.

9. The apparatus of claim 7, wherein the bus is an I²C bus.

10. The apparatus of claim 1, wherein the processing mechanism comprises one of:
an embedded-class processor; or
a microcontroller.

11. A system, comprising:
a plurality of sled devices, each sled device comprising one or more servers and a corresponding embedded management controller coupled to each server; and
a system management controller, comprising:
a processing mechanism; and
a plurality of internal interfaces coupled to the processing mechanism, each internal interface coupled to each embedded management controller on a corresponding one of the sled devices, each embedded management controller facilitating communications between the processing mechanism and a corresponding server;
wherein the processing mechanism is configured to manage one or more operations of the servers on the plurality of sled devices.

12. The system of claim 11, wherein the processing mechanism is configured to:
request information associated with a server from a corresponding embedded management controller via a corresponding internal interface; and
receive a response including the information from the corresponding embedded management controller via the corresponding internal interface, wherein the information is acquired by the corresponding embedded management controller from the server.

13. The system of claim 11, further comprising:
a plurality of external interfaces coupled to the processing mechanism, each external interface configured to be coupled to at least one external device.

14. The system of claim 13, wherein the processing mechanism is configured to send one or more communications to one or more external devices using corresponding external interfaces.

15. The system of claim 13, wherein the plurality of external interfaces coupled to the processing mechanism comprise one or more interfaces selected from the following group:
a serial interface;
a fan controller interface;
a network interface;
a front panel interface;
an I²C interface;
a power supply interface; and
a memory interface.

16. The system of claim 11, further comprising:
a memory coupled to the processing mechanism, wherein the memory is configured to store data and instructions for the processing mechanism.

17. The system of claim 11, further comprising:
a bus coupled between all of the embedded management controllers on each of the sled devices and the corresponding internal interface on the system management controller.

18. The system of claim 17, wherein the bus is an Ethernet bus.

19. The system of claim 17, wherein the bus is an I²C bus.

20. The system of claim 11, wherein the processing mechanism comprises one of:
an embedded-class processor; or
a microcontroller.

21. A method for managing one or more servers on one or more sled devices, comprising:
in a system management controller, performing a management function for a server by:
when information associated with the server is to be retrieved, requesting the information from an embedded management controller coupled to the server, wherein the embedded management controller acquires the information from the server and returns the information to the system management controller; and
when a command is to be sent from the system management controller to the server, sending a command to the embedded management controller, wherein the embedded management controller communicates a corresponding command to the server.

22. The method of claim 21, wherein requesting the information from the embedded management controller comprises:
sending a message to the embedded management controller, the message causing the embedded management controller to at least one of acquire the information from the server or acquire the information from a memory in the embedded management controller and to return the information to the system management controller in a response; and
receiving the response from the embedded management controller.

23. The method of claim 21, wherein sending the command to the embedded management controller comprises:
generating a message to be communicated to the embedded management controller, the message comprising an indication of the command to be sent to the server by the embedded management controller; and
communicating the message to the server.

24. The method of claim 21, further comprising:
when an external device is to be communicated with by the system management controller as part of performing the management function, communicating with the external device.
